(19) United States
(12) Patent Application Publication
(10) Pub. No.: US 2026/0352586 A1
(43) Pub. Date: Nov. 5, 2026

(54) SMART FABRIC DEPLOYMENT FOR LARGE-SCALE HIGH-PERFORMANCE COMPUTING AND ARTIFICIAL INTELLIGENCE SYSTEMS

(71) Applicant: Hewlett Packard Enterprise Development LP, Spring, TX (US)

(72) Inventors: Nilakantan Mahadevan, Minneapolis, MN (US); Laurence Scott Kaplan, Shoreline, WA (US)

(21) Appl. No.: 19/195,316

(22) Filed: Apr. 30, 2025

(51) Int. Cl. H04L 43/50; H04L 41/12; H04L 41/14

(52) U.S. Cl. CPC H04L 43/50; H04L 41/12; H04L 41/14

(57) ABSTRACT

A system generates a dependency graph based on a topology of components in a network. The system creates, based on the dependency graph, workflow templates which indicate diagnostic tests to be performed on the components and instructions for obtaining augmented data related to the network. The system deploys the workflow templates by performing the diagnostic tests and executing the instructions. The system performs an analysis based on results of the diagnostic tests and augmented data obtained by executing the instructions. The system triggers an action to be performed on a component based on the analysis.

### BACKGROUND

Deploying a switch fabric in High-Performance Computing (HPC) and artificial intelligence (AI) systems involves physical installation, software/hardware diagnostics, and multi-level revalidation across network components such as switches, ports, links, racks, and full systems. This process faces challenges including system failures caused by undetected component defects, operational errors due to misordered initialization sequences, external disruptions like power fluctuations, and cascading revalidation requirements after component replacements. These complex deployments often extend time-to-production to weeks or months.

### BRIEF DESCRIPTION OF THE FIGURES

FIG. 1A illustrates a high-level flow of a system which facilitates smart fabric deployment for large-scale HPC and AI systems, in accordance with an aspect of the present application.

FIG. 1B illustrates an environment, including a fabric deployment engine, which facilitates smart fabric deployment for large-scale HPC and AI systems, in accordance with an aspect of the present application.

FIG. 2A illustrates a logical/topological representation of a network fabric on which smart fabric deployment for large-scale HPC and AI systems can be used, in accordance with an aspect of the present application.

FIG. 2B illustrates a physical representation of components in a network fabric similar to the network fabric in FIG. 2A, in accordance with an aspect of the present application.

FIG. 3 illustrates a dependency graph illustrating the relationship between components in a network, in accordance with an aspect of the present application.

FIG. 4 illustrates a workflow for the use case of adding a new rack, in accordance with an aspect of the present application.

FIG. 5A illustrates a workflow for the use case of replacing a cable, based on the dependency graph in FIG. 5B, in accordance with an aspect of the present application.

FIG. 5B illustrates the dependency graph for the use case of replacing a cable, in accordance with an aspect of the present application.

FIG. 6A illustrates a workflow for the use case of replacing a network interface card (NIC), based on the dependency graph in FIG. 6B, in accordance with an aspect of the present application.

FIG. 6B illustrates the dependency graph for the use case of replacing a NIC, in accordance with an aspect of the present application.

FIG. 7A illustrates a workflow for the use case of replacing a switch, based on the dependency graph in FIG. 7B, in accordance with an aspect of the present application.

FIG. 7B illustrates the dependency graph for the use case of replacing a switch, in accordance with an aspect of the present application.

FIGS. 8A and 8B present flowcharts illustrating a method which facilitates smart fabric deployment for large-scale HPC and AI systems, in accordance with an aspect of the present application.

FIG. 9 illustrates a computer system which facilitates smart fabric deployment for large-scale HPC and AI systems, in accordance with an aspect of the present application.

FIG. 10 illustrates a computer-readable medium which facilitates smart fabric deployment for large-scale HPC and AI systems, in accordance with an aspect of the present application.

In the figures, like reference numerals refer to the same figure elements.

### DETAILED DESCRIPTION

Aspects of the present application provide a smart fabric deployment that generates a dependency graph mapping component relationships based on system topology, creates workflow templates that specify diagnostic tests based on the dependency graph, and executes the workflow templates to validate the fabric deployment and to further revalidate replaced components. In addition to specifying the diagnostic tests to be performed on the components, the workflow templates may indicate instructions for obtaining augmented data related to the network, e.g., additional annotations on telemetry which may not be obtained as a direct result of performing the diagnostic tests on a given component. The described aspects may subsequently perform analysis of the results of the diagnostic tests based on the augmented data, e.g., by identifying a correlation between the results and the augmented data and by using the correlation to determine whether to create a ticket resulting in a hardware component replacement and a subsequent revalidation of the replaced component.

Deploying a switch fabric in High-Performance Computing (HPC) systems involves physical installation, software/hardware diagnostics, and multi-level revalidation across network components. A typical infrastructure may include racks with chassis that include hosts and switches, and a network fabric may include switches and high-speed network interfaces on the hosts. A centralized fabric manager may provide management services for the fabric, e.g., by interacting with switch software and other controllers on a switch. A host may include additional software that enables the high-speed network interfaces to provide a certain level of reliability towards lossless traffic. A host may also include subsystems with hardware components, e.g., a graphical processor unit (GPU), high bandwidth memory (HBM), a central processing unit (CPU), dual in-line memory module (DIMM) as memory for the CPU, and Peripheral Component Interconnect Express (PCIe) components.

Based on the number of hardware and software components involved in a large scale HPC system, deploying a switch fabric may face challenges including system failures caused by undetected component defects, operational errors due to misordered initialization sequences, external disruptions like power fluctuations, and cascading revalidation requirements after component replacements. Furthermore, the lack of isolated validation may cause disruption to the rest of the system. These complex deployments often extend time-to-production to weeks or months.

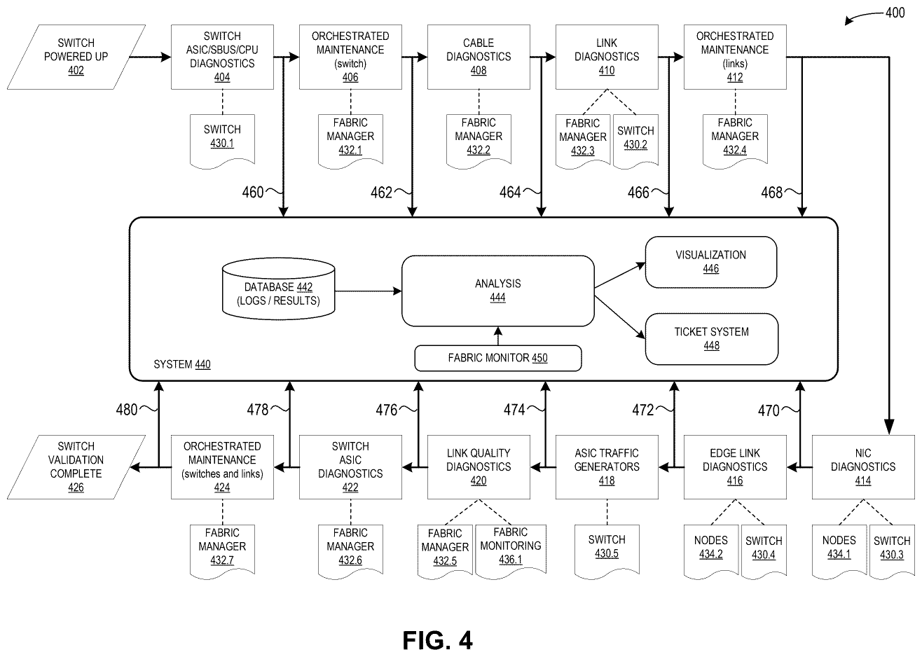

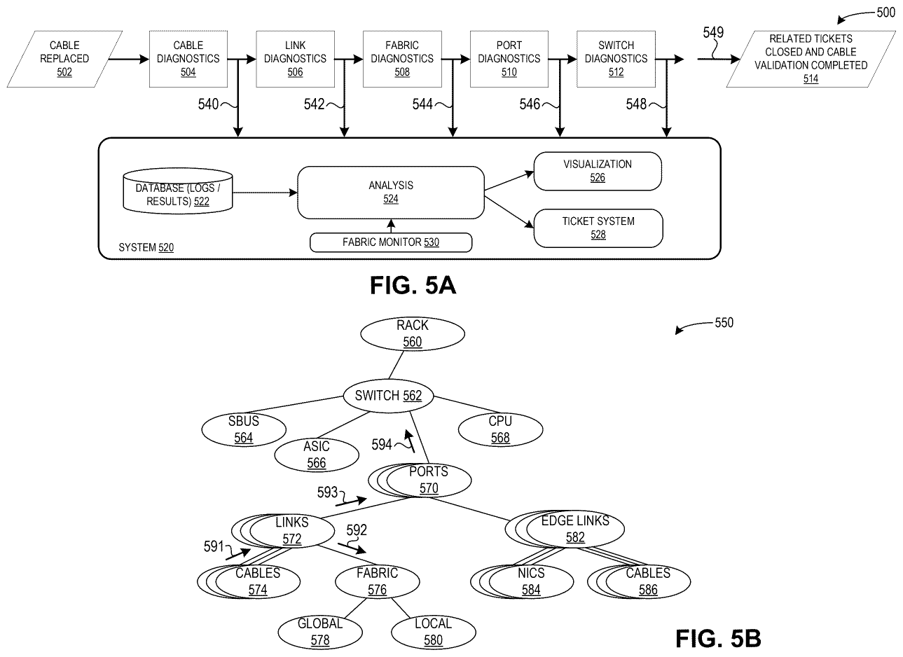

The described aspects address these limitations by providing a system which generates a relationship hierarchy (i.e., a dependency graph) between components of the network based on the topology of the components. The system creates an automated workflow validation based on the dependency graph and the state of the fabric. For example, the system can create custom workflow templates for various scenarios, including bringing up a new rack, and adding or replacing a hardware component (e.g., a NIC, a cable, or a switch), as described below in relation to the use cases in FIGS. 4, 5A/5B, 6A/6B, and 7A/7B.

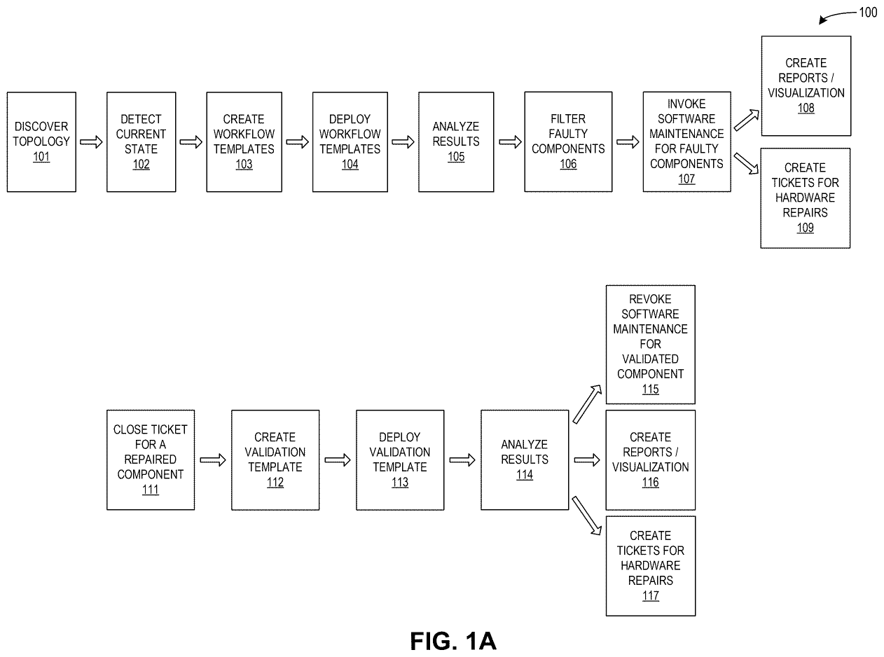

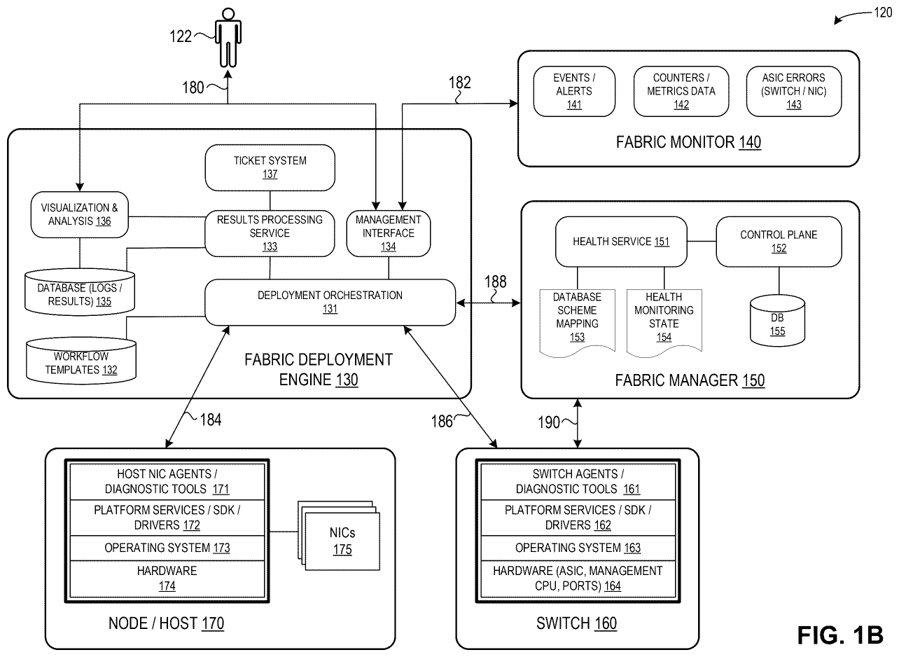

FIG. 1A illustrates a high-level flow 100 of a system which facilitates smart fabric deployment for large-scale HPC and AI systems, in accordance with an aspect of the present application. The system first discovers a topology of the network components (101), e.g., based on standard information exchanged or obtained when on-boarding new components or devices to a network. The system may detect or determine the current state of the network (102). For example, the system may execute commands to test basic connectivity of one network component to another network component or may check settings of a network device (such as a switch) to determine the current connection status. The system may also use a network monitoring tool to capture and analyze network traffic to determine the current network state.

The system may create workflow templates (103) which may indicate certain diagnostic tests to be run as well as a specific set of instructions. For example, the diagnostic tests may be for link validation, and the specific set of instructions may be for obtaining augmented data related to the network. The augmented data may include information which may not be obtained from performing the component-specific diagnostic tests, but which information may be subsequently used to perform correlations and identify additional issues. The augmented data may be obtained from an entity which monitors operation of the network, e.g., a fabric health monitor. Examples of augmented data may include the link level retry rate, the number of link flaps observed during a specific period of time, etc.

The system may deploy the workflow templates (104). For example, the system may deploy a workflow template on a switch, and the workflow template may indicate specific diagnostic tests to be run on the switch. The switch-specific diagnostic tests may relate to an application-specific integrated circuit (ASIC), serial bus (SBUS), or CPU associated with the switch, as described below in relation to switch diagnostic tests 404 in FIG. 4.

The system may analyze the results of the diagnostic tests and the augmented data (105), e.g., by identifying a correlation between the results and the augmented data. If the system identifies any faulty components, the system may filter out the faulty components (106). For example, if the system determines, based on results of performing the switch diagnostic tests, that a switch is faulty, the system may exclude the faulty switch from operation of the system and thus prevent interference by the faulty component.

The system may invoke software maintenance on the faulty components (107). For example, subsequent to determining that a switch is faulty based on failing to meet certain predetermined thresholds or thresholds defined by the diagnostic tests, the system may place that faulty switch into software maintenance mode, which may allow a user handling an open ticket to swap the faulty switch out for new hardware (i.e., a new switch).

After analyzing the results and placing faulty components into software maintenance mode, the system may create reports and data for visualization (108). The visualization may include a status and results of the diagnostic tests performed on each component, along with whether any action has been taken or is to be taken on a particular component. For example, a user may use a management interface with a fabric deployment engine to view such reports and data, as described below in relation to user 122 using management interface 134 to access data generated by visualization and analysis unit 136 of fabric deployment engine 130 in FIG. 1B.

The system may also create tickets for hardware repairs (109). The system may be integrated with a ticket subsystem which allows the user to perform an action (such as replacing a faulty switch or other hardware component) and subsequently close the ticket. For example, based on the information generated by visualization and analysis unit 136 in FIG. 1B, the system may create an open ticket in ticket system 137, and the open ticket may indicate that a faulty component (identified in operation 105) needs to be replaced

Upon closing the ticket for a repaired component (111) (e.g., by using a management interface to interact with data or reports displayed for visualization as integrated with a ticket system), the system may create validation workflow templates (112) and may deploy those validation workflow templates (113), in a similar manner as creating and deploying the workflow templates indicated by modules 103 and 104. Creating and deploying validation workflow templates subsequent to replacing or repairing a component and closing the corresponding ticket is described below in relation to the use cases of FIGS. 5A/5B, 6A/6B, and 7A/7B.

The system may analyze the results of deploying the validation templates (114), which may trigger an action including one of the following: if the validation of the repaired component is successful, the system may revoke the software maintenance for the validated component (115), which may result in the component being included in further diagnostic tests; the system may create reports and data for visualization (116) by a user, as described below in relation to visualization and analysis unit 136 in FIG. 1B; and the system may create tickets for hardware repairs (117), similar to the actions described above for modules 108 and 109.

FIG. 1B illustrates an environment 120, including a fabric deployment engine 130, which facilitates smart fabric deployment for large-scale HPC and AI systems, in accordance with an aspect of the present application. Environment 120 may include multiple systems or subsystems with elements, modules, or units that perform the operations described herein, e.g.: fabric deployment engine (FDE) 130; a fabric monitor 140; a fabric manager 150; a switch 160; and a node/host 170. FDE 130 may include a deployment orchestration unit 131, which manages communication with the hardware components of a fabric, as depicted by a communication 184 to/from host 170 and a communication 186 to/from switch 160. FDE 130 may also include: a database 132 storing workflow templates; a database 135 storing logs, results from diagnostics, augmented data, and other related information; a results processing service 133 which performs analysis of the information stored in database 135; a visualization and analysis unit 136 which displays various information relating to the status of validating components (e.g., the results of the diagnostic tests) and also performs analysis on the results of the diagnostic tests and augmented data stored in database 135, including identifying correlations; a management interface 134 via which a user 122 may interact with FDE 130 via a communication 180; and a ticket system 137 integrated with FDE 130 and triggered based on the analysis performed by results processing service 133. User 122 may interact with the system (specifically, with management interface 134 and visualization and analysis unit 136 of FDE 130 via communication 180). For example, user 122 may use management interface 134 to view data in ticket system 137 based on data and reports generated by visualization and analysis unit 136. User 122 may also use management interface 134 to enter information relating to an open ticket or to close a ticket upon performance of an action associated with the ticket (e.g., replacing a faulty hardware component).

While the elements in FDE 130 are depicted as communicating with each other in a particular manner (based on the solid lines between elements), the operations of FDE 130 may be performed by more or fewer entities or components, and the communications are depicted for illustrative purposes.

Fabric monitor 140 may perform tasks related to tracking operation of the network fabric, including the switches and network interface cards (NICs) associated with the network fabric. Based on tracking the operation of the fabric network, fabric monitor 140 may store, e.g.: events/alerts 141; counters/metrics data 142; and ASIC errors 143 related to a switch or a NIC. Fabric monitor 140 may send health data or other monitored data to FDE 130 via a communication 182. FDE 130 may receive the health data at its management interface (via communication 182) or by another element (not shown).

Fabric manager 150 may include: a health service 151 which operates based on a database scheme mapping 153 and a health monitoring state 154; and a control plane 152 which communicates with a database 155 to store information relevant for monitoring and managing the elements in the network fabric. Fabric manager 150 may also include diagnostic tools that are invoked by FDE 130 as part of the deployed workflow templates. Fabric manager 150 may communicate with FDE 130 (via a communication 188), e.g., by sending switch configuration information or discovery-related information to FDE 130, or by invoking diagnostic tools to be run by fabric manager 150. Fabric manager 150 may also communicate with switch 160 (via a communication 190), e.g., by sending alerts based on monitored health data.

Switch 160 may include: switch agents/diagnostic tools 161; platform services/software development kits (SDKs)/drivers 162; an operating system 163; and hardware 164 (e.g., ASIC, management CPU, and ports). Similarly, host 170 may include: host agents/diagnostic tools 171; platform services/SDKs/drivers 172; an operating system 173; and hardware 174.

FDE 130 may deploy certain workflow templates on host 170, and host 170 may return results of diagnostic tests indicated in the workflow templates (via communication 184). Similarly, FDE 130 may deploy certain workflow templates on switch 160, and switch 160 may return the results of diagnostic tests indicated in those workflow templates (via communication 186). Deploying the workflow templates may also result in invoking certain diagnostic tools on fabric manager 150 (as described above in relation to communication 188).

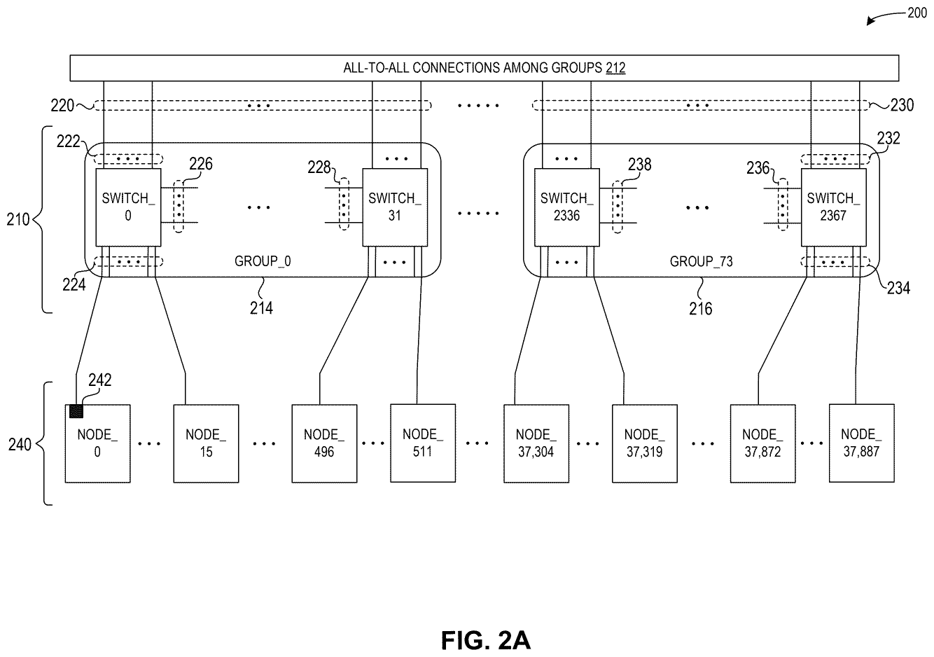

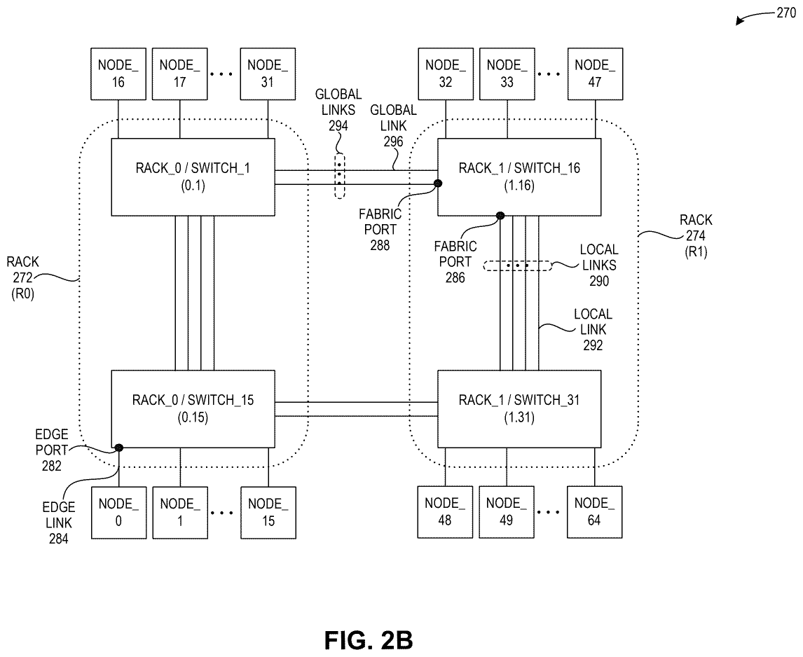

FIG. 2A illustrates a logical/topological representation of a network fabric 200 on which smart fabric deployment for large-scale HPC and AI systems can be used, in accordance with an aspect of the present application. The described aspects of the smart fabric deployment may be deployed across most types of hierarchical networks, e.g., a dragonfly network, a fat tree network, etc. While the networks described in FIGS. 2A and 2B illustrate a dragonfly network, the described aspects are not limited to dragonfly networks and may include networks with other hierarchical topologies. Network fabric 200 may include a hierarchical network connected as an example dragonfly network which includes 74 groups of switches, where each group includes 32 switches, for a total of 2,368 switches. Each switch may be connected to 4 nodes which each have 4 NICs, for a total of 16 nodes connected to each switch and 512 nodes per group, for a total of 37,888 nodes.

Specifically, network fabric 200 may include a plurality of groups, e.g., 74 groups including a group_0 (214) and a group_73 (216) (as indicated by a hierarchical layer element 210). Each group may include a plurality of network devices, e.g.: group_0 (214) may include 32 switches (e.g., including a switch 0 and a switch 31); and group_1 (216) may include 32 switches (e.g., including a switch 2336 and a switch 2367). The plurality of network devices in a respective group may be connected to each other in an all-to-all manner. For example: the 32 switches in group_0 may be connected to each other in an all-to-all manner (as indicated by links 226 and 228); and the 32 switches in group_1 may be connected to each other in an all-to-all manner (as indicated by links 238 and 236). The groups in the plurality of groups may be connected to each other via a plurality of global links in an all-to-all manner. For example, the 74 groups indicated by element 210 may be connected to each other via 74 global links (as indicated by elements 220 and 230, as well as the all-to-all connections among groups 212).

Each network device may be coupled to one or more endpoint or processing nodes, e.g., 37,888 nodes including a node_0, a node_15, a node_496, a node_511, a node_37304, a node_37319, a node_37872, and a node_37887 (as indicated by a hierarchical layer element 240). In the example dragonfly network of FIG. 2A, each node may include multiple network interface controllers (NICs) (indicated by, e.g., a dark square 242 on node_0), which may provide connection, coupling, or communication with ports or links on the network devices.

FIG. 2B illustrates a physical representation of components in a network fabric 270 similar to the example network fabric 200 in FIG. 2A, in accordance with an aspect of the present application. Network fabric 270 may include switches in racks which communicate with switches in a same or a different rack. While the term “group” is used in describing the exemplary dragonfly network of FIG. 2A, network fabric 270 depicts these “groups” generally as “racks.” In network fabric 270, a rack 272 (depicted as rack_0 or R0) may include a switch_1 and a switch_15 (denoted respectively as “switch 0.1” and “switch 0.15”). In addition, a rack 274 (depicted as rack_1 or R1) may include a switch_16 and a switch_31 (denoted respectively as “switch 1.16” and “switch 1.31”).

The switches in the two depicted racks (R0 and R1) may be coupled to a plurality of nodes via edge ports and edge links. Switch 0.15 may be coupled to at least node_0, node_1, and node_15; switch 0.1 may be coupled to at least node_16, node_17, and node_31; switch 1.16 may be coupled to at least node_32, node_33, and node_47; and switch 1.31 may be coupled to at least node_48, node_49, and node_64. For example, switch 0.15 may be coupled to node_1 via an edge port 282 and an edge link 284.

The switches in a rack may be coupled to other switches in the same rack via a fabric port over a local link. For example, switch 1.16 may be coupled to switch 1.31 via a fabric port 286 and a local link 292 (of local links 290, which may couple to other switches in the same rack).

The switches in a rack may also be coupled to other switches in a different rack via a fabric port over a global ink. For example, switch 1.16 (in rack 274) may be coupled to switch 0.1 (in rack 272) via a fabric port 288 and a global link 296 (of global links 294, which may couple to other switches in the different rack).

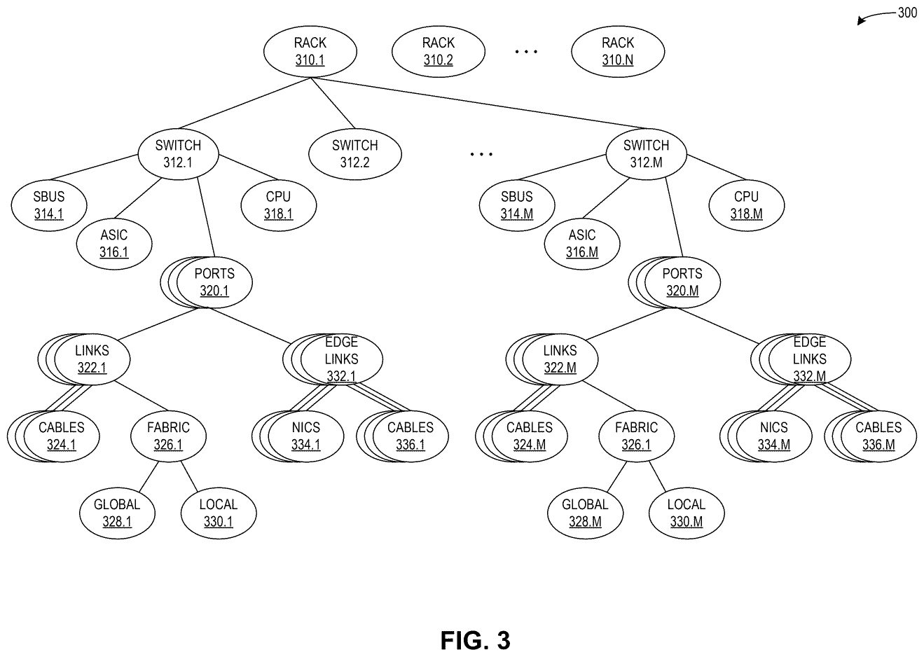

FIG. 3 illustrates a dependency graph 300 illustrating the relationship between components in a network, in accordance with an aspect of the present application. The system can generate a dependency graph similar to dependency graph 300 as a result of discovering the topology of a network. Dependency graph 300 indicates that an infrastructure or system may include or depend on multiple racks (e.g., racks 310.1, 310.2, and 310.N). Each rack may include or depend on multiple switches (e.g., switches 312.1, 312.2, and 312.M). Each switch may include or depend on various components. For example, switch 312.1 may include or depend on: a serial bus (SBUS) 314.1; an ASIC 316.1; a CPU 318.1; and multiple ports 320.1. Each port may be coupled to multiple links, including internal (i.e., fabric) links 322.1 and edge links 332.1. Internal links may depend on cables 324.1 and may be fabric links (326.1) which are either global fabric links (328.1) or local fabric links (330.1). The nodes for fabric, global, and local links are depicted in dependency graph 300 to represent the different types of internal fabric links on which a specific port may depend and thus may need to be tested. Edge links 332.1 may depend on NICs 334.1 and cables 336.1.

Similarly, the dependency graph for switch 312.M indicates that switch 312.M may include or depend on: an SBUS 314.M; an ASIC 316.M; a CPU 318.M; and multiple ports 320.M. Each port may be coupled to multiple links, including internal (e.g., fabric) links 322.M and edge links 332.M. Internal links may depend on cables 324.M and may be fabric links (326.M) which are either global fabric links (328.M) or local fabric links (330.M). Edge links 332.M may depend on NICs 334.M and cables 336.M.

FIG. 4 illustrates a workflow 400 for the use case of adding a new rack, in accordance with an aspect of the present application. Each set of actions (e.g., diagnostic tests or orchestrated maintenance) appears in a rectangular box. The top row of actions may occur as part of initial fabric deployment when adding the new rack, while the bottom row of actions may occur as part of continuing diagnostics after filtering out the initially detected faulty components. At each action (i.e., after running a particular set of diagnostic tests or placing a hardware component into an orchestrated software maintenance mode), the system may store the results (e.g., logs) of the diagnostic tests in database 442 (e.g., via communications 460-480). Concurrently, the deployed workflow template may include instructions for annotation, e.g., to collect or obtain augmented data from fabric monitor 450. The system (by analysis module 444) may perform an analysis, e.g., based on the results or by identifying a correlation between the results stored in a database 442 and the augmented data obtained from fabric monitor 450. Analysis module 444 may determine whether the analysis triggers an action, e.g., creating a ticket (by ticket system 448), displaying data for visualization (by visualization module 446), etc. For example, visualization module 446 may display on a screen: an indicator of which workflow templates have been or are to be deployed to which components; an overview of the diagnostic tests and instructions for annotation included in a given workflow template; a status of the diagnostic tests; results of the diagnostic tests; the augmented data obtained as a result of deploying the workflow template with the instructions for annotation; a ticket indicating an action to be taken for a given component; a status of the ticket; an indicator of which validation-related workflow templates have been or are to be deployed to which components; and a status/results of validation-related diagnostic tests and augmented data obtained as a result of deploying the validation-related workflow templates with instructions for annotation.

The system can perform each action by running diagnostic tests on a particular related hardware component or by obtaining information from another entity or network component. When adding a new rack to a network fabric, the system performs diagnostics on each switch in the network fabric along with all of the components on which each switch depends. In workflow 400 of FIG. 4, each set of diagnostic tests may interact with other components or entities (as indicated by a dotted line to, e.g., a switch, a node, a fabric manager, a fabric monitor, etc.). The use case validation flows in FIGS. 5A, 6A, and 7A also include interaction by each set of diagnostic tests with similar entities as in FIG. 4 (e.g., switch 430, fabric manager 432, nodes 434, and fabric monitoring 436), but these entities are omitted for purposes of illustration. In addition, after performing switch diagnostic tests or link diagnostic tests, in response to identifying a faulty component, the system may place that faulty component into an orchestrated software maintenance mode (depicted in FIG. 4, but not shown in each of the use case validation flows in FIGS. 5A, 6A, and 7A). Placing a faulty component into orchestrated maintenance mode may enable the validation of the rest of the system by excluding the faulty component from operation of the system and thus preventing interference by the faulty component.

In FIG. 4, an input event may indicate that a switch in the network fabric is powered up (402). System 440 can run switch ASIC/SBUS/CPU diagnostic tests (404), which may be run on the switch itself (430.1), and system 440 can store the results of those diagnostic tests in database 442 (via communication 460) for subsequent analysis and potential ticket creation. If the results indicate a faulty component, system 440 may place the faulty component (here, the switch) in an orchestrated software maintenance mode (406), during which time the fabric manager (432.1) may invoke certain software programs or routines to test or maintain the switch, while facilitating a hardware repair with minimal disruption to the system. System 440 may store in database 442 results related to placing the faulty switch into software maintenance mode (via communication 462) for subsequent analysis and potential ticket creation.

Next, system 440 can run cable diagnostic tests (408), which may involve executing tools on the fabric manager and obtaining certain information from the fabric manager (432.2). System 440 can write those results to database 442 (via a communication 464) for subsequent analysis and potential ticket creation. System 440 can then run link diagnostics (410), which may involve both obtaining information from the fabric manager (432.3) and running the link diagnostics on the switch itself (430.2). System 440 can store the results of those diagnostic tests in database 442 (via communication 466) for subsequent analysis and potential ticket creation. If the results indicate a faulty component, system 440 may again place the faulty component (here, the link) in an orchestrated software maintenance mode (412), during which time the fabric manager (432.4) may test or maintain the switch to allow a hardware repair of the component with minimal disruption to the system. System 440 may exchange information with the fabric manager (432.4) as part of the software maintenance. System 440 can store in database 442 results related to placing the faulty link into software maintenance mode (via a communication 468) for subsequent analysis and potential ticket creation.

System 440 may continue its validation of the new switch (input at 402) by performing NIC diagnostic tests (414) based on interactions with the nodes (434.1) and the switch (430.3). System 440 may then store the results in database 442 (via a communication 470) for subsequent analysis and potential ticket creation. Similarly, system 440 may perform edge link diagnostic tests (416) based on interactions with the nodes (434.2) and the switch (430.4) and store the results in database 442 (via a communication 472) for subsequent analysis and potential ticket creation.

System 440 may also include modules that generate test traffic, such as ASIC traffic generators (418), to be run on the switch (430.5) and may further store those results in database 442 (via communication 474) for subsequent analysis and potential ticket creation. System 440 may perform additional link quality diagnostic tests (420) and switch diagnostics (422), which may detect ASIC errors such as critical errors or mean bias errors. As part of the link quality diagnostics (420), the fabric manager (432.5) may configure, test, or maintain the link and the fabric monitor (436.1) may track and send data related to the health or quality of the link; as part of the switch ASIC diagnostics (422), the fabric manager (432.6) may also configure, test, or maintain information associated with the ASIC of the switch. System 440 may store the results of those tests in database 442 (via, respectively, communications 476 and 478) for subsequent analysis and potential ticket creation. Finally, system 440 may place any identified components (switches or links) into software maintenance mode (424) and send to database 442 any results or information related to placing the component into software maintenance mode (via communication 480). System 440 may exchange information with the fabric manager (432.7) as part of the software maintenance. Once any relevant information has been stored in database 442, system 440 may output a signal or message that the validation of the switch is complete (426).

FIG. 5A illustrates a workflow 500 for the use case of replacing a cable, based on dependency graph 550 in FIG. 5B, in accordance with an aspect of the present application. FIG. 5B illustrates dependency graph 550 for the use case of replacing a cable, in accordance with an aspect of the present application. In FIG. 5A, system 520 may include similar elements as system 440 in FIG. 4 (such as a database 522, an analysis module 524, a fabric monitor 530, a visualization module 526, and a ticket system 528). The depicted steps of workflow 500 may occur after a cable has been identified as faulty (e.g., based on cable diagnostics 408 and result 464 in FIG. 4), a ticket has been created for replacing the faulty cable, the faulty cable has been replaced by a new cable, and the ticket has been closed. These events can trigger revalidation of the new cable, i.e., validation workflow 500 may include deploying validation-related workflow templates and validation-related instructions for the specific use case of replacing a cable.

Dependency graph 550 in FIG. 5B, similar to dependency graph 300 of FIG. 3, depicts that an infrastructure or system may include or depend on multiple racks (e.g., a rack 560), and a rack may include or depend on multiple switches (e.g., a switch 562). Each switch may include or depend on various components. For example, switch 562 may include or depend on: an SBUS 564; an ASIC 566; a CPU 568; and multiple ports 570. Each port may be coupled to multiple links, including internal (i.e., fabric) links 572 and edge links 582. Internal links may depend on cables 574 and may be fabric links (576) which are either global fabric links (578) or local fabric links (580). The nodes for fabric, global, and local are depicted to represent the different types of internal fabric links upon which a specific port may depend and thus may need to be tested. Edge links 582 may depend on NICs 584 and cables 586.

In FIG. 5A, an input event to validation workflow 500 may indicate that a cable in the network fabric has been replaced (502). System 520 may execute a deployed validation-related workflow template for this use case, and the workflow template may be based on traversing dependency graph 550 from the node representing the replaced component, first to its child nodes (if any) and then to its parent nodes. Based on dependency graph 550, system 520 may run the following diagnostic tests in an order specified by the traversal of dependency graph 550: cable diagnostics 504 (indicated by cables 574); link diagnostics 506 (indicated by a traversal 591 to links 572); fabric diagnostics 508 (indicated by a traversal 592 to fabric 576); port diagnostics 510 (indicated by a traversal 593 to ports 570); and switch diagnostics 512 (indicated by a traversal 594 to switch 562). Subsequent to performing each set of diagnostics, system 520 can write to database 522 the results of those tests, as well as any augmented data obtained from other entities based on the annotated instructions in the validation-related workflow templates, via, e.g., respectively, communications 540-548. Upon determining that the revalidation tests have been successfully performed and that any tickets created as a result of the cable validation workflow have been closed (via a communication 549), system 520 may determine that the cable validation is complete (indicated as an output 514 from workflow 500).

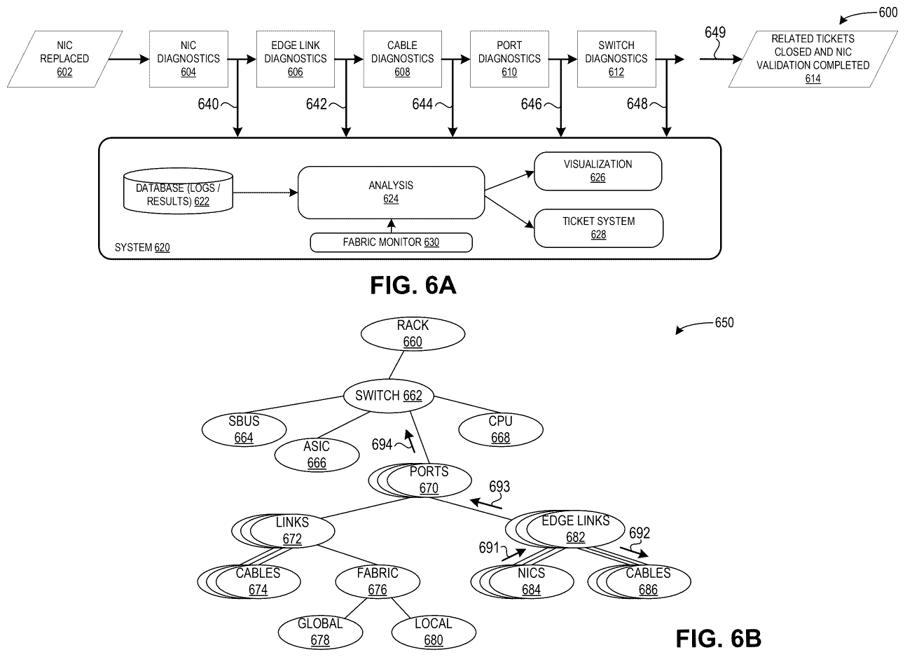

FIG. 6A illustrates a workflow 600 for the use case of replacing a NIC, based on dependency graph 650 in FIG. 6B, in accordance with an aspect of the present application. FIG. 6B illustrates dependency graph 650 for the use case of replacing a NIC, in accordance with an aspect of the present application. In FIG. 6A, system 620 may include similar elements as system 440 in FIG. 4 (such as a database 622, an analysis module 624, a fabric monitor 630, a visualization module 626, and a ticket system 628). The depicted steps of workflow 600 may occur after a NIC has been identified as faulty (e.g., based on NIC diagnostics 414 and result 470 in FIG. 4), a ticket has been created for replacing the faulty NIC, the faulty NIC has been replaced with a new NIC, and the ticket has been closed. These events can trigger revalidation of the new NIC, i.e., validation workflow 600 may include deploying validation-related workflow templates and validation-related instructions for the specific use case of replacing a NIC.

Dependency graph 650 in FIG. 6B, similar to dependency graph 300 of FIG. 3, depicts that an infrastructure or system may include or depend on multiple racks (e.g., a rack 660), and a rack may include or depend on multiple switches (e.g., a switch 662). Each switch may include or depend on various components. For example, switch 662 may include or depend on: an SBUS 664; an ASIC 666; a CPU 668; and multiple ports 670. Each port may be coupled to multiple links, including internal (i.e., fabric) links 672 and edge links 682. Internal links may depend on cables 674 and may be fabric links (676) which are either global fabric links (678) or local fabric links (680). The nodes for fabric, global, and local are depicted to represent the different types of internal fabric links upon which a specific port may depend and thus may need to be tested. Edge links 682 may depend on NICs 684 and cables 686.

In FIG. 6A, an input event to validation workflow 600 may indicate that a NIC in the network fabric has been replaced (602). System 620 may execute a deployed validation-related workflow template for this use case, and the workflow template may be based on traversing dependency graph 650 from the node representing the replaced component, first to its child nodes (if any) and then to its parent nodes. Based on dependency graph 650, system 620 may run the following diagnostic tests in an order specified by the traversal of dependency graph 550: NIC diagnostics 604 (indicated by NICs 684); edge link diagnostics 606 (indicated by a traversal 691 to edge links 682); cable diagnostics 608 (indicated by a traversal 692 to cables 686); port diagnostics 610 (indicated by a traversal 693 to ports 670); and switch diagnostics 612 (indicated by a traversal 694 to switch 662). Subsequent to performing each set of diagnostics, system 620 may write to database 622 the results of those tests, as well as any augmented data obtained from other entities based on the annotated instructions in the validation-related workflow templates, via, e.g., respectively, communications 640-648. Upon determining that the revalidation tests have been successfully performed and that any tickets created as a result of the NIC validation workflow have been closed (via a communication 649), system 620 may determine that the NIC validation is complete (indicated as an output 614 from workflow 600).

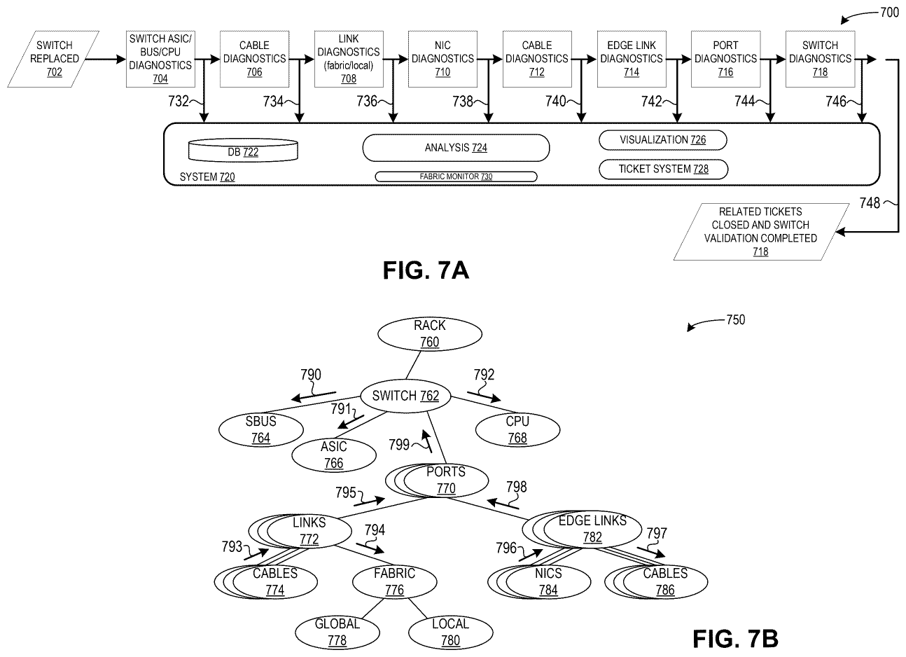

FIG. 7A illustrates a workflow 700 for the use case of replacing a switch, based on dependency graph 750 in FIG. 7B, in accordance with an aspect of the present application. FIG. 7B illustrates dependency graph 750 for the use case of replacing a switch, in accordance with an aspect of the present application. In FIG. 7A, system 720 may include similar elements as system 440 in FIG. 4 (such as a database 722, an analysis module 724, a fabric monitor 730, a visualization module 726, and a ticket system 728). The depicted steps of workflow 700 may occur after a switch has been identified as faulty (e.g., based on switch diagnostics 404/switch ASIC errors 422 and, respectively, results 460 and 478 in FIG. 4), a ticket has been created for the faulty switch, the faulty switch has been replaced with a new switch, and the ticket has been closed. These events can trigger revalidation of the new switch, i.e., validation workflow 700 may include deploying validation-related workflow templates and validation-related instructions for the specific use case of replacing a switch.

Dependency graph 750 in FIG. 7B, similar to dependency graph 300 of FIG. 3, depicts that an infrastructure or system may include or depend on multiple racks (e.g., a rack 760), and a rack may include or depend on multiple switches (e.g., a switch 762). Each switch may include or depend on various components. For example, switch 762 may include or depend on: an SBUS 764; an ASIC 766; a CPU 768; and multiple ports 770. Each port may be coupled to multiple links, including internal (i.e., fabric) links 772 and edge links 782. Internal links may depend on cables 774 and may be fabric links (776) which are either global fabric links (778) or local fabric links (780). The nodes for fabric, global, and local are depicted to represent the different types of internal fabric links upon which a specific port may depend and thus may need to be tested. Edge links 782 may depend on NICs 784 and cables 786.

In FIG. 7A, an input event to validation workflow 700 may indicate that a switch in the network fabric has been replaced (702). System 720 may execute a deployed validation-related workflow template for this use case, and the workflow template may be based on traversing dependency graph 750 from the node representing the replaced component, first to its child nodes (if any) and then to its parent nodes. Based on dependency graph 750, system 720 may run the following diagnostic tests in an order specified by the traversal of dependency graph 750: switch ASIC/BUS/CPU diagnostics 704 (indicated, from switch 762, by a traversal 790 to SBUS 764, a traversal 791 to ASIC 766, and a traversal 792 to CPU 768); cable diagnostics 706 (indicated by a traversal down to the child node of cables 774); link diagnostics (fabric and local) 708 (indicated by a traversal 793 to links 772); NIC diagnostics 710 (indicated by a traversal down to child node NICs 784); cable diagnostics 712 (indicated by a traversal 797 to cables 786); edge link diagnostics 714 (indicated by edge links 782); port diagnostics 716 (indicated by a traversal 798 to ports 770); and switch diagnostics 718 (indicated by a traversal 799 to switch 762). Subsequent to performing each set of diagnostics, system 720 can write to database 722 the results of those tests, as well as any augmented data obtained from other entities based on the annotated instructions in the validation-related workflow templates, via, e.g., respectively, communications 732-746. Upon determining that the revalidation tests have been successfully performed and that any tickets created as a result of the switch validation workflow have been closed (via a communication 748), system 720 can determine that the switch validation is complete (indicated as an output 718 from workflow 700).

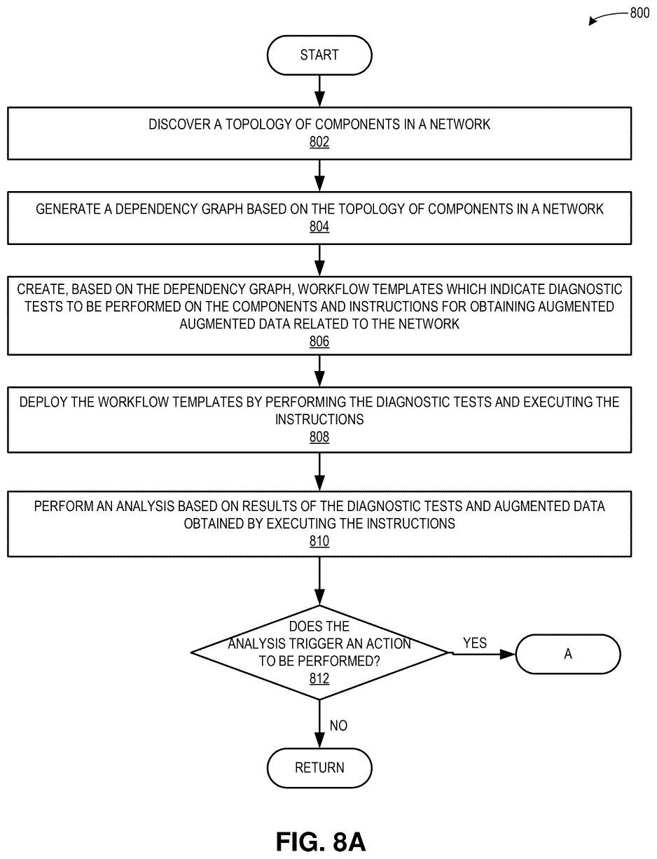

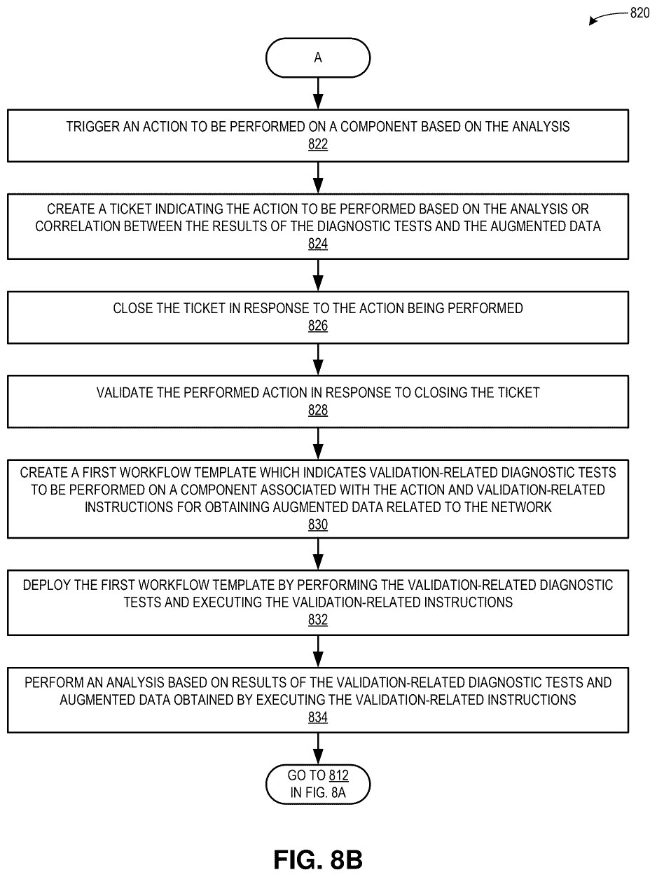

FIGS. 8A and 8B present flowcharts 800 and 820 illustrating a method which facilitates smart fabric deployment for large-scale HPC and AI systems, in accordance with an aspect of the present application. In flowchart 800 of FIG. 8A, the system discovers a topology of components in a network (operation 802). The system may discover or detect a network topology based on standard information exchanged or obtained when on-boarding new components or devices to a network, as described above in relation to module 101 of FIG. 1A and the communications with FDE 130 in FIG. 1B.

The system generates a dependency graph based on a topology of components in a network (operation 804). For example, the dependency graph may be generated for an infrastructure which includes multiple racks, and each rack may include multiple switches. Each switch may be coupled to host or NIC nodes via edge ports over edge links. Each switch may further be coupled to other switches in a same rack (or group, in the case of a dragonfly network) via fabric ports over local fabric links and may further be coupled to other switches in a different rack via fabric ports over global fabric links. A sample topology is described above in relation to FIGS. 2A and 2B, and a generated dependency graph is described above in relation to FIG. 3.

The system creates, based on the dependency graph, workflow templates which indicate diagnostic tests to be performed on the components and instructions for obtaining augmented data related to the network (operation 806). As described above in relation to module 102 of FIG. 1A, the workflow templates may indicate certain diagnostic tests to be run relating to a particular component of the topology, e.g., running cable diagnostics on an identified cable in the dependency graph, depicted as cable diagnostics 408 of FIG. 4. The workflow templates may also include a specific set of instructions for obtaining augmented data related to the network. The augmented data may include information which may not be specifically related to the cable validation, but may be subsequently used to perform correlations and identify additional issues, e.g., PCIe error rate or other health monitoring data obtained from fabric monitor 450 in FIG. 4. The system may store the workflow templates in a database maintained or accessible to, e.g., workflow templates 132 accessible by deployment orchestration module 131 in fabric deployment engine 130 of FIG. 1B.

The system deploys the workflow templates by performing the diagnostic tests and executing the instructions (operation 808). In FIG. 1B, fabric deployment engine 130 may deploy workflow templates 132 to host/node 170 and switch 160 via, respectively, communications 184 and 186. Host/node 170 and switch 160 may perform the diagnostic tests indicated in the deployed workflow templates and may also execute instructions included or indicated in the deployed workflow templates, as described above in relation to modules 103 and 104 of FIG. 1A, communications 184 and 186 of FIG. 1B, and the operations depicted in FIG. 4.

The system performs an analysis based on results of the diagnostic tests and augmented data obtained by executing the instructions (operation 810). In one aspect, results processing service 133 of fabric deployment engine 130 in FIG. 1B may obtain, from database 135, the results of the diagnostic tests as well as any data obtained by executing the instructions indicated in the deployed workflow templates. Similarly, analysis module 444 in FIG. 4 may obtain similar data from database 442 (e.g., results and logs) as well as health-related data from fabric monitor 450. Analysis module 444 may perform an analysis of this data, e.g., by identifying a correlation between the results of the diagnostic tests and the augmented data. Analyzing results is described above in relation to module 105 of FIG. 1A and analysis modules 524, 624, and 724 of, respectively, FIGS. 5A, 6A, and 7A.

The system determines if the analysis triggers an action to be performed (decision 812). For example, the system may compare the results and augmented data against predetermined benchmarks or thresholds to determine whether to trigger an action. If the analysis does trigger an action (decision 812), the operation continues at Label A in FIG. 8B. If it does not (decision 812), the operation returns.

In flowchart 820 of FIG. 8B, the system triggers an action to be performed on a component based on the analysis (operation 822). The action to be performed may include, e.g.: replacing or adding a NIC; replacing or adding a cable associated with a global link between switch in different racks; replacing or adding a cable associated with a local link between switches in same rack; replacing or adding a switch in a rack; or adding a new rack in a system. For example, the analysis performed by the system may indicate that a switch is faulty, and the system may then place that faulty switch in software maintenance mode, as described above in relation to switch diagnostic tests 404 and orchestrated maintenance 406 in FIG. 4 as well as in relation to modules 106 and 107 of FIG. 1A. As another example, the analysis may include identifying a correlation between the results of link diagnostics 410 and augmented data obtained from fabric monitor 450 (e.g., the link level retry rate falls below a certain predetermined threshold), as described above in relation to FIG. 4. Identifying the correlation may trigger the action to be performed.

The system creates a ticket indicating the action to be performed based on the analysis or correlation between the results of the diagnostic tests and the augmented data (operation 824). For example, in FIG. 1B, visualization and analysis unit 136 may perform an analysis of the results of diagnostic tests and augmented data, and, based on an identified correlation (as determined by the analysis of operation 810), the system may determine that the analysis triggers an action (e.g., the analysis may indicate that a cable is faulty), and the system may create a ticket indicating that the faulty cable is to be replaced. Storing results of diagnostic tests and augmented data is described above in relation to communications 460-480 in FIG. 4.

The system closes the ticket in response to the action being performed (operation 826). In FIG. 1B, a user 122 of the system, interfacing with ticket system 137 via management interface 134, may perform the action indicated by the ticket, e.g., replacing or adding a new hardware component to the system. User 122 (or another user) may subsequently close the ticket, as described above in relation to module 111 of FIG. 1A.

The system validates the performed action in response to closing the ticket (operation 828). For example, given an action on an object such as replacing a cable, the system may validate the replacement or other action related to addressing the issue or component (e.g., the object) indicated in the ticket, by deploying a validation-related workflow template and sequentially performing diagnostic tests related to validating the given object, as depicted above in relation to the use case workflow diagram and corresponding dependency graph of FIGS. 5A/5B, 6A/6B, and 7A/7B. The system may validate the performed action through the series of operations detailed below in operations 830-834.

The system creates a first workflow template which indicates validation-related diagnostic tests to be performed on a component associated with the action and validation-related instructions for obtaining augmented data related to the network (operation 830), as described above in relation to module 112 of FIG. 1A and workflow templates 132 of fabric deployment engine 130 in FIG. 1B.

The system deploys the first workflow template by performing the validation-related diagnostic tests and executing the validation-related instructions (operation 832). The system may create these validation-related workflow templates based on the results of the diagnostic tests and the augmented data. The validation-related workflow templates may include additional or other diagnostic tests which are specific to the component associated with the results or correlation. The system may deploy these validation-related workflow templates in a similar manner as described above for creating and deploying the workflow templates in modules 103 and 104 of FIG. 1A.

The system performs an analysis based on results of the validation-related diagnostic tests and augmented data obtained by executing the validation-related instructions (operation 834), similar to the analysis described above in relation to module 105 of FIG. 1A and modules 524, 624, and 724 of, respectively, FIGS. 5A, 6A, and 7A, as well as module 114 of FIG. 1A. The system may also perform the analysis by identifying a correlation between the results of the validation-related diagnostic tests and the augmented data obtained by executing the validation-related instructions in the validation workflow template.

The operation continues at operation 812 in FIG. 8A (i.e., determining whether the analysis triggers an action to be performed). As described above, the action to be performed may include replacing or adding a component to the system or overall network topology, as in the use cases for replacing a cable, replacing a NIC, and replacing a switch in, respectively, FIGS. 5A, 6A, and 7A.

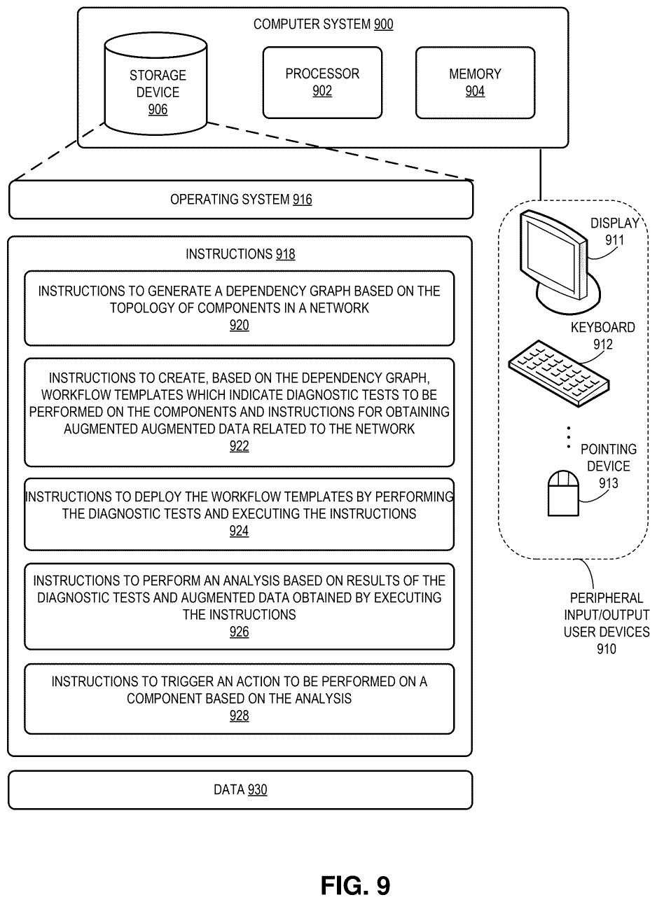

FIG. 9 illustrates a computer system which facilitates smart fabric deployment for large-scale HPC and AI systems, in accordance with an aspect of the present application. Computer system 900 includes a processor 902, a memory 904, and a storage device 906. Memory 904 may include a volatile memory (e.g., random access memory (RAM)) that serves as a managed memory and may be used to store one or more memory pools. Furthermore, computer system 900 may be coupled to peripheral I/O user devices 910 (e.g., a display device 911, a keyboard 912, and a pointing device 913). Storage device 906 includes non-transitory computer-readable storage medium and stores an operating system 916, instructions 918, and data 930. Computer system 900 may include fewer or more entities or instructions than those shown in FIG. 9.

Instructions 918 can include instructions, which when executed by computer system 900, may cause computer system 900 to perform methods and/or processes described in this disclosure. Specifically, instructions 918 may include instructions 920 to generate a dependency graph based on a topology of components in a network, as described above in relation to FIGS. 2A, 2B, and 3 as well as operations 802 and 804 of FIG. 8A.

Instructions 918 may also include instructions 922 to create, based on the dependency graph, workflow templates which indicate diagnostic tests to be performed on the components and instructions for obtaining augmented data related to the network, as described above in relation to FIGS. 1A and 4 as well as operation 806 of FIG. 8A.

Instructions 918 may also include instructions 924 to deploy the workflow templates by performing the diagnostic tests and executing the instructions, as described above in relation to FIGS. 1A, 1B, and 4 as well as operation 808 of FIG. 8A.

Instructions 918 may also include instructions 926 to perform an analysis based on results of the diagnostic tests and augmented data obtained by executing the instructions, as described above in relation to the analysis modules of FIGS. 1A, 4, 5A, 6A, and 7A as well as operation 810 of FIG. 8A.

Instructions 918 may also include instructions 928 to trigger an action to be performed on a component based on the analysis, as described above in relation to FIGS. 1 and 4 as well as decision 812 of FIG. 8A and operation 822 of FIG. 8B.

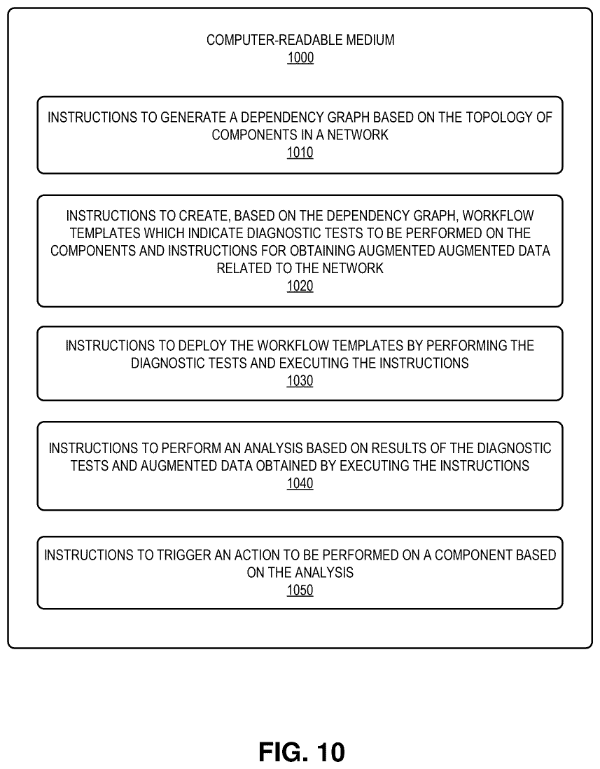

Instructions 918 may include more instructions than those shown in FIG. 9. For example, instructions 918 may include instructions for executing the operations described above in relation to: the high-level flow of FIG. 1A; the environment of FIG. 1B; the exemplary networks of FIGS. 2A and 2B; the dependency graph of FIG. 3; the workflows and dependency graphs of FIGS. 4, 5A, 5B, 6A, 6B, 7A, and 7B; and the instructions of CRM 1000 in FIG. 10.

Data 930 can include any data that is required as input or that is generated as output by the methods, operations, communications, and/or processes described in this disclosure. Specifically, data 930 may store at least: a topology of components in a network; a graph; a dependency graph; a workflow template; a validate-related workflow template; a diagnostic test; instructions for obtaining augmented data which is not a result of performing diagnostic tests or is obtained from an entity which monitors operation of a network; validation-related instructions; an indicator of a faulty component; data; health monitoring data; a ticket; an open ticket; a closed ticket; an indicator of an action to be performed; a correlation; a predetermined rule; a predetermined threshold; results of diagnostic tests; and augmented data obtained from executing instructions.

FIG. 10 illustrates a computer-readable medium (CRM) 1000 which facilitates smart fabric deployment for large-scale HPC and AI systems, in accordance with an aspect of the present application. CRM 1000 can be a non-transitory computer-readable medium or device storing instructions that when executed by a computer or processor cause the computer or processor to perform a method. CRM 1000 may store instructions 1010 to generate a dependency graph based on a topology of components in a network, as described above in relation to FIGS. 2A, 2B, and 3 as well as operations 802 and 804 of FIG. 8A

CRM 1000 may store instructions 1020 to create, based on the dependency graph, workflow templates which indicate diagnostic tests to be performed on the components and instructions for obtaining augmented data related to the network, as described above in relation to FIGS. 1A and 4 as well as operation 806 of FIG. 8A.

CRM 1000 may store instructions 1030 to deploy the workflow template by performing the diagnostic tests and executing the instructions, as described above in relation to FIGS. 1A, 1B, and 4 as well as operation 808 of FIG. 8A.

CRM 1000 may store instructions 1040 to perform an analysis based on results of the diagnostic tests and augmented data obtained by executing the instructions, as described above in relation to the analysis modules of FIGS. 1A, 4, 5A, 6A, and 7A as well as operation 810 of FIG. 8A.

CRM 1000 may store instructions 1050 to trigger an action to be performed on a component based on the analysis, as described above in relation to FIGS. 1 and 4 as well as decision 812 of FIG. 8A and operation 822 of FIG. 8B.

CRM 1000 may include more instructions than those shown in FIG. 10. For example, CRM 1000 may store instructions for executing the operations described above in relation to: the high-level flow of FIG. 1A; the environment of FIG. 1B; the exemplary networks of FIGS. 2A and 2B; the dependency graph of FIG. 3; the workflows and dependency graphs of FIGS. 4, 5A, 5B, 6A, 6B, 7A, and 7B; and instructions 918 of computer system 900 in FIG. 9.

Thus, the described aspects can provide a smart fabric deployment for large-scale HPC and AI systems, e.g., by generating a dependency graph of a topology of components in a network, creating and deploying workflow templates on various components, analyzing results of diagnostic tests and augmented data, integrating with a ticket system, replacing hardware components based on tickets created from the analysis, and performing re-validation of the replaced components.

In general, the disclosed aspects provide a method, a computer system, and a computer-readable medium which facilitate smart fabric deployment for large-scale HPC and AI systems. During operation, the system generates a dependency graph based on a topology of components in a network. The system creates, based on the dependency graph, workflow templates which indicate diagnostic tests to be performed on the components and instructions for obtaining augmented data related to the network. The system deploys the workflow templates by performing the diagnostic tests and executing the instructions. The system performs an analysis based on results of the diagnostic tests and augmented data obtained by executing the instructions. The system triggers an action to be performed on a component based on the analysis.

In a variation on this aspect, the system discovers the topology of the components in the network and detects a state of the topology of the components in the network.

In a further variation on this aspect, the components comprise at least one of: a switch; a port; a link; a cable; a network interface card (NIC); a rack; or a system.

In a further variation on this aspect, the port comprises at least one of: an internal-facing port coupled to a fabric link connecting switches in a same fabric; or an external-facing port coupled to at least one of: a NIC, a host, a compute node, another network, or a hardware component associated with the other network.

In a further variation, the augmented data related to the network comprises at least one of: information obtained which is not a result of performing the diagnostic tests; or information obtained from an entity which monitors operation of the network.

In a further variation, triggering the action comprises: creating a ticket indicating the action to be performed based on at least one of the analysis or correlation between the results of the diagnostic tests and the augmented data; and placing a component associated with the action in a maintenance mode. The system closes the ticket in response to the action being performed.

In a further variation, the system validates the performed action in response to closing the ticket. Validating the performed action comprises: creating a first workflow template which indicates validation-related diagnostic tests to be performed on the component associated with the action and validation-related instructions for obtaining augmented data related to the network; deploying the first workflow template by performing the validation-related diagnostic tests and executing the validation-related instructions; and performing an analysis based on results of the validation-related diagnostic tests and augmented data obtained by executing the validation-related instructions.

In a further variation, the action comprises at least one of: replacing or adding a NIC; replacing or adding a cable associated with a fabric link connecting two switches; replacing or adding a switch in a rack; or adding a new rack in a system.

In a further variation, the system identifies the correlation between the results of executing the diagnostic tests and the augmented data based on at least one of: a predetermined rule; or observation or analysis by a user associated with the network.

In a further variation, the system provides a first visualization in response to performing the diagnostic tests and executing the instructions. The system provides a second visualization in response to performing the analysis. The system provides a third visualization in response to validating the action. The system displays information associated with at least one of: the dependency graph; the topology of the components; the workflow templates; the first workflow template; the action to be performed based on the analysis; or a status of the ticket indicating the action to be performed.

In a further variation, the diagnostic tests indicated in a respective workflow template are associated with a component on which the diagnostic tests are to be performed. The system sequentially performs the diagnostic tests based on at least one of: a first traversal of the dependency graph, from a node indicating the component being non-functional to a child node indicating another component upon which the non-functional component depends; or a second traversal of the dependency graph, from the node indicating the non-functional component to a parent node indicating another component which depends upon the non-functional component.

In another aspect, a computer system comprises a processing resource and a storage device storing instructions which when executed by the processing resource cause the processing resource to perform a method (i.e., instructions to perform the method). The method comprises generating a dependency graph based on a topology of components in a network. The method further comprises creating, based on the dependency graph, workflow templates which indicate diagnostic tests to be performed on the components and instructions for obtaining augmented data related to the network. The method further comprises deploying the workflow templates by performing the diagnostic tests and executing the instructions. The method further comprises performing an analysis based on results of the diagnostic tests and augmented data obtained by executing the instructions. The method further comprises triggering an action to be performed on a component based on the analysis. The computer system may include other instructions to perform the operations described herein, including in relation to: the high-level flow of FIG. 1A; the environment of FIG. 1B; the exemplary networks of FIGS. 2A and 2B; the dependency graph of FIG. 3; the workflows and dependency graphs of FIGS. 4, 5A, 5B, 6A, 6B, 7A, and 7B; and the instructions of CRM 1000 in FIG. 10.

In another aspect, a non-transitory computer-readable storage medium (or CRM) stores instructions which when executed by a processing resource cause the processing resource to perform a method (i.e., instructions to perform the method). The method comprises generating a dependency graph based on a topology of components in a network. The method further comprises creating, based on the dependency graph, workflow templates which indicate diagnostic tests to be performed on the components and instructions for obtaining augmented data related to the network. The method further comprises deploying the workflow template by performing the diagnostic tests and executing the instructions. The method further comprises performing an analysis based on results of the diagnostic tests and augmented data obtained by executing the instructions. The method further comprises triggering an action to be performed on a component based on the analysis. The CRM may also store instructions for executing the operations described above in relation to: the high-level flow of FIG. 1A; the environment of FIG. 1B; the exemplary networks of FIGS. 2A and 2B; the dependency graph of FIG. 3; the workflows and dependency graphs of FIGS. 4, 5A, 5B, 6A, 6B, 7A, and 7B; and instructions 918 of computer system 900 in FIG. 9.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
generating a dependency graph based on a topology of components in a network;
creating, based on the dependency graph, workflow templates which indicate diagnostic tests to be performed on the components and instructions for obtaining augmented data related to the network;
deploying the workflow templates by performing the diagnostic tests and executing the instructions;
performing an analysis based on results of the diagnostic tests and augmented data obtained by executing the instructions; and
triggering an action to be performed on a component based on the analysis.

2. The method of claim 1, further comprising:
discovering the topology of the components in the network; and
detecting a state of the topology of the components in the network.

3. The method of claim 1, the components comprising at least one of:
a switch;
a port;
a link;
a cable;
a network interface card (NIC);
a rack; or
a system.

4. The method of claim 3, the port comprising at least one of:
an internal-facing port coupled to a fabric link connecting switches in a same fabric; or
an external-facing port coupled to at least one of: a NIC, a host, a compute node, another network, or a hardware component associated with the other network.

5. The method of claim 1, the augmented data related to the network comprising at least one of:
information obtained which is not a result of performing the diagnostic tests; or
information obtained from an entity which monitors operation of the network.

6. The method of claim 1,
wherein triggering the action comprises:
creating a ticket indicating the action to be performed based on at least one of:
the analysis; or
correlation between the results of the diagnostic tests and the augmented data; and
placing a component associated with the action in a maintenance mode; and
wherein the method further comprises closing the ticket in response to the action being performed.

7. The method of claim 6, further comprising:
validating the performed action in response to closing the ticket,
wherein validating the performed action comprises:
creating a first workflow template which indicates validation-related diagnostic tests to be performed on the component associated with the action and validation-related instructions for obtaining augmented data related to the network;
deploying the first workflow template by performing the validation-related diagnostic tests and executing the validation-related instructions; and
performing an analysis based on results of the validation-related diagnostic tests and augmented data obtained by executing the validation-related instructions.

8. The method of claim 6, the action comprising at least one of:
replacing or adding a NIC;
replacing or adding a cable associated with a fabric link connecting two switches;
replacing or adding a switch in a rack; or
adding a new rack in a system.

9. The method of claim 6, further comprising:
identifying the correlation between the results of executing the diagnostic tests and the augmented data based on at least one of:
a predetermined rule; or
observation or analysis by a user associated with the network.

10. The method of claim 6, further comprising:
providing a first visualization in response to performing the diagnostic tests and executing the instructions;
providing a second visualization in response to performing the analysis;
providing a third visualization in response to validating the action; and
displaying information associated with at least one of:
the dependency graph;
the topology of the components;
the workflow templates;
the first workflow template;
the action to be performed based on the analysis; or
a status of the ticket indicating the action to be performed.

11. The method of claim 1,
wherein the diagnostic tests indicated in a respective workflow template are associated with a component on which the diagnostic tests are to be performed; and
wherein the method further comprises sequentially performing the diagnostic tests based on at least one of:
a first traversal of the dependency graph, from a node indicating the component being non-functional to a child node indicating another component upon which the non-functional component depends; or
a second traversal of the dependency graph, from the node indicating the non-functional component to a parent node indicating another component which depends upon the non-functional component.

12. A computing system comprising:
a processing resource; and
a storage device storing instructions which when executed by the processing resource cause the processing resource to perform a method, the method comprising:
generating a dependency graph based on a topology of components in a network;
creating, based on the dependency graph, workflow templates which indicate diagnostic tests to be performed on the components and instructions for obtaining augmented data related to the network;
deploying the workflow templates by performing the diagnostic tests and executing the instructions;
performing an analysis based on results of the diagnostic tests and augmented data obtained by executing the instructions; and
triggering an action to be performed on a component based on the analysis.

13. The computing system of claim 12,
wherein the diagnostic tests indicated in a respective workflow template are associated with a component on which the diagnostic tests are to be performed, and
wherein the augmented data related to the network comprises at least one of:
information obtained which is not a result of performing the diagnostic tests; or
information obtained from an entity which monitors operation of the network.

14. The computing system of claim 12,
wherein triggering the action comprises:
creating a ticket indicating the action to be performed based on at least one of:
the analysis; or
correlation between the results of the diagnostic tests and the augmented data; and
placing a component associated with the action in a maintenance mode; and
wherein the method further comprises:
closing the ticket in response to the action being performed; and
validating the performed action in response to closing the ticket,
wherein validating the performed action comprises:
creating a first workflow template which indicates validation-related diagnostic tests to be performed on the component associated with the action and validation-related instructions for obtaining augmented data related to the network;
deploying the first workflow template by performing the validation-related diagnostic tests and executing the validation-related instructions; and
performing an analysis based on results of the validation-related diagnostic tests and augmented data obtained by executing the validation-related instructions.

15. The computing system of claim 14, wherein the method further comprises:
providing a first visualization in response to performing the diagnostic tests and executing the instructions;
providing a second visualization in response to performing the analysis;
providing a third visualization in response to validating the action; and
displaying information associated with at least one of:
the dependency graph;
the topology of the components;
the workflow templates or the first workflow template;
the action to be performed based on the analysis; or
a status of the ticket indicating the action to be performed.

16. The computing system of claim 12, wherein the method is performed in response to deploying the network as a network fabric in at least one of:
a manufacturing facility; or
premises of a customer or third party.

17. A non-transitory computer-readable medium storing instructions which when executed by a processing resource cause the processing resource to perform a method, the method comprising:
generating a dependency graph based on a topology of components in a network;
creating, based on the dependency graph, workflow templates which indicate diagnostic tests to be performed on the components and instructions for obtaining augmented data related to the network;
deploying the workflow template by performing the diagnostic tests and executing the instructions;
performing an analysis based on results of the diagnostic tests and augmented data obtained by executing the instructions; and
triggering an action to be performed on a component based on the analysis.

18. The non-transitory computer-readable medium of claim 17,
wherein triggering the action comprises:
creating a ticket indicating the action to be performed based on at least one of:
the analysis; or
correlation between the results of the diagnostic tests and the augmented data; and
placing a component associated with the action in a maintenance mode; and
wherein the method further comprises:
closing the ticket in response to the action being performed; and
validating the performed action in response to closing the ticket,
wherein validating the performed action comprises:
creating a first workflow template which indicates validation-related diagnostic tests to be performed on the component associated with the action and validation-related instructions for obtaining augmented data related to the network;
deploying the first workflow template by performing the validation-related diagnostic tests and executing the validation-related instructions; and
performing an analysis based on results of the validation-related diagnostic tests and augmented data obtained by executing the validation-related instructions.

19. The non-transitory computer-readable medium of claim 18, wherein the action comprises at least one of:
replacing or adding a network interface card (NIC);
replacing or adding a cable associated with a fabric link connecting two switches;
replacing or adding a switch in a rack;
adding a new rack in a system; or
changing the topology of one or more components in the network.

20. The non-transitory computer-readable medium of claim 17,
wherein the diagnostic tests indicated in a respective workflow template are associated with a component on which the diagnostic tests are to be performed; and
wherein the method further comprises sequentially performing the diagnostic tests based on at least one of:
a first traversal of the dependency graph, from a node indicating the component being non-functional to a child node indicating another component upon which the non-functional component depends; or
a second traversal of the dependency graph, from the node indicating the non-functional component to a parent node indicating another component which depends upon the non-functional component.
